(19) United States
(12) Patent Application Publication
(10) Pub. No.: US 2011/0205165 A1
(43) Pub. Date: Aug. 25, 2011

(54) TUNED MASS DAMPER FOR IMPROVING NVH CHARACTERISTICS OF A HAPTIC TOUCH PANEL

(76) Inventors: Douglas Allen Pfau, Canton, MI (US); David Michael Whitton, Saline, MI (US); Muqtada Husain, Brownstown, MI (US)

(21) Appl. No.: 12/711,635

(22) Filed: Feb. 24, 2010

(51) Int. Cl. G06F 3/041; G09G 5/00

(52) U.S. Cl. 345/173; 345/156; 340/407.1

(57) ABSTRACT

A haptic interface is disclosed. The haptic interface includes a base having a front surface. A haptic member is disposed adjacent the front surface of the base to receive an input from a user. An actuator is interposed between the base and the haptic member. A control system is provided that is in electrical communication with the haptic member and the actuator, wherein the control system receives the input from the haptic member effective to control an operation of the control system and provides an output to the actuator to produce a vibration of the haptic member having a frequency domain and a peak amplitude. A tuned mass damper is coupled to the haptic interface, wherein the tuned mass damper minimizes the peak amplitude of the vibration and minimizes a transfer of the vibration from the haptic member to a support structure.

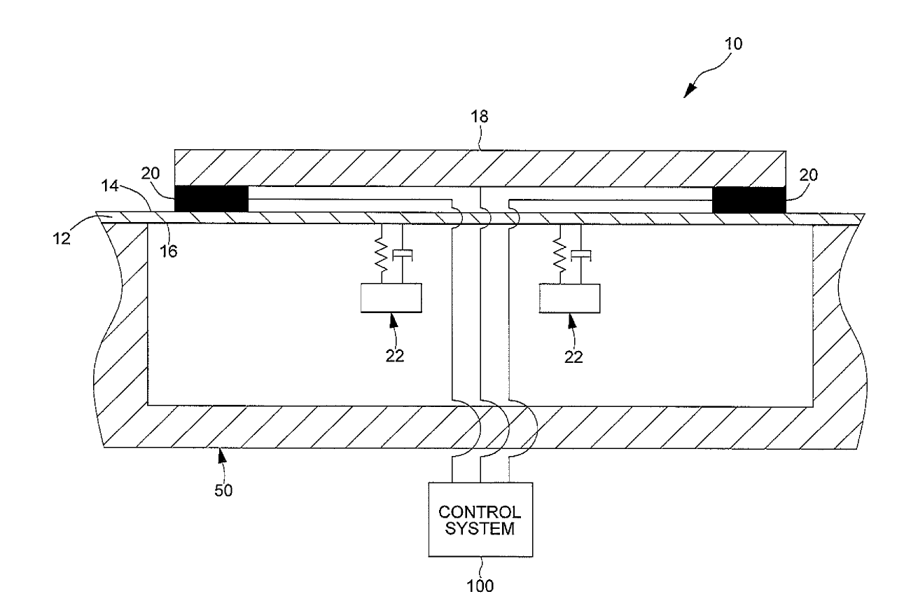

### FIELD OF THE INVENTION

The present invention relates to haptics. More particularly, the invention is directed to the use of a tuned mass damper to reduce undesirable vibrations introduced into a support structure for a haptic touch panel.

### BACKGROUND OF THE INVENTION

Haptic technology refers to technology which interfaces a user via the sense of touch by applying mechanical stimulation such as forces, vibrations, and other motions to the user. This mechanical stimulation is used in many modern electronic controls such as rotary, push button, and solid state switches and touch panels and touch screens, for example, to form a haptic interface. The mechanical stimulation provided by the haptic interface is used to indicate to the user the operational status or condition of an apparatus or other item being operated by the user through the haptic interface.

The haptic interface can be attached to a support structure such as a control panel and incorporated into a vehicle dashboard, for example. The mechanical stimulation provided by the haptic interface may be transmitted to the support structure and produce undesirable noise, vibration, and harshness (NVH) characteristics in the support structure and other components attached thereto. Additional mass may be added to the support structure and other components attached thereto to minimize undesirable NVH characteristics. However, the additional mass typically results in increased material and assembly costs and may have other undesirable consequences such as reduced fuel economy in vehicles, for example.

It would be desirable to produce a haptic interface, wherein a transmission of a mechanical stimulation from the haptic interface to a support structure therefore is minimized.

### SUMMARY OF THE INVENTION

Compatible and attuned with the present invention, a haptic interface, wherein a transmission of a mechanical stimulation from the haptic interface to a support structure therefore is minimized, has surprisingly been discovered.

In one embodiment, a base having a front surface; a haptic member disposed adjacent the front surface of the base to receive an input from a user, the haptic member in electrical communication with a control system, wherein the control system receives the input from the haptic member; an actuator interposed between the base and the haptic member, the actuator in electrical communication with the control system, wherein the control system selectively provides an output to the actuator causing the actuator to produce a vibration of the haptic member, the vibration having a frequency domain and a peak amplitude; a tuned mass damper coupled to the haptic interface, wherein the tuned mass damper minimizes the peak amplitude of the vibration.

In another embodiment, a base having a front surface and a back surface; a haptic member disposed adjacent the front surface of the base to receive an input from a user, an actuator interposed between the base and the haptic member, a control system in electrical communication with the haptic member and the actuator, wherein the control system receives the input from the haptic member effective to control an operation of the control system and selectively provides an output to the actuator to produce a vibration of the haptic member, the vibration having a frequency domain and a peak amplitude; and a tuned mass damper coupled to the haptic interface, wherein the tuned mass damper minimizes the peak amplitude of the vibration.

The invention also provides methods for reducing a peak amplitude of a vibration in a haptic interface. One method comprises the steps of providing a haptic interface comprising a base having a front surface; a haptic member disposed adjacent the front surface of the base to receive an input from a user, the haptic member in electrical communication with a control system, wherein the control system receives the input from the haptic member; an actuator interposed between the base and the haptic member, the actuator in electrical communication with the control system, wherein the control system selectively provides an output to the actuator causing the actuator to produce a vibration of the haptic member, the vibration having a frequency domain and a peak amplitude; and a tuned mass damper coupled to the haptic interface; and mounting the haptic interface to a support structure, wherein the tuned mass damper minimizes the peak amplitude of the vibration to minimize a transfer of the vibration from the haptic member to the support structure.

### BRIEF DESCRIPTION OF THE DRAWING

The above, as well as other advantages of the present invention, will become readily apparent to those skilled in the art from the following detailed description of the preferred embodiment when considered in the light of the accompanying drawing in which is a schematic fragmentary cross sectional view of a haptic interface according to an embodiment of the present invention.

### DETAILED DESCRIPTION OF EXEMPLARY EMBODIMENTS OF THE INVENTION

The following detailed description and appended drawing describe and illustrate various embodiments of the invention. The description and drawing serve to enable one skilled in the art to make and use the invention, and are not intended to limit the scope of the invention in any manner. In respect of the methods disclosed, the steps presented are exemplary in nature, and thus, the order of the steps is not necessary or critical.

Referring to the drawing, there is illustrated a haptic interface assembly 10 according to an embodiment of the present invention. As shown, the haptic interface assembly 10 is coupled to a support structure 50 and in electrical communication with a control system 100 such as the haptic effect control system described in commonly owned U.S. patent application Ser. No. 12/193,060, hereby incorporated herein by reference in its entirety, or as is otherwise known in the art. The haptic interface assembly 10 is used to provide inputs to the control system 100 to control an operation of an associated system or device such as an HVAC system, a sound system, an automated bank teller, and a vending machine, for example. The control system 100 provides outputs to the haptic interface assembly 10 to produce a mechanical stimulation such as a vibration in the haptic interface assembly 10. The mechanical stimulation of the haptic interface assembly 10 indicates to the user an operational status or condition of the associated system or device. The support structure 50 can be a control panel, a housing for the associated system or device, and a dashboard or other surface of a vehicle, for example. The haptic interface assembly 10 is typically mounted to the support structure 50 in a manner to provide ready access to the user. For example, the haptic interface assembly 10 can be mounted to, or be part of a control panel and a dashboard of an automobile, wherein the haptic interface assembly 10 is used together with the control system 100 to control the operation of HVAC systems, sound systems, and other accessories typically provided in vehicles

The haptic interface assembly 10 includes a base 12 having a front surface 14 and a back surface 16. A haptic member 18 is provided adjacent the front surface 14 of the base 12. In the illustrated embodiment, the haptic member 18 is one of a touch panel, a touch screen, a resistive sensing switch, and a capacitive sensing switch as is known in the art. It should be understood that the haptic member 18 can be a rotary switch, a push button switch, a solid state switch, an infrared switch, and any other type of switch or control interface now known or later developed, for example. It should be understood that the haptic member 18 can include one or more switches. The haptic member 18 receives an input from the user and transmits the input to the control system 100.

An actuator 20 is interposed between the front surface 14 of the base 12 and the haptic member 18. In the illustrated embodiment, a pair of actuators 20 is shown. It should be understood that a single actuator 20 can be used and more than two actuators 20 can be used. It should also be understood that the actuator 20 can be a solenoid actuator, an electrical motor, a piezoelectric actuator, and an electrostatic actuator, for example. The actuator 20 is coupled to the front surface 14 of the base 12 and the haptic member 18. The actuator 20 is in electrical communication with the control system 100. An output is transmitted to the actuator 20 to selectively energize the actuator 20. When the actuator 20 is energized by the control system 100, the actuator 20 provides an energy input to the haptic interface assembly 10 to cause the mechanical stimulation which may be a relative movement between the base 12 and the haptic member 18. The relative movement between the base 12 and the haptic member 18 is felt by the user as the vibration when the user is in physical contact with the haptic member 18 such as when the user touches the haptic member 18 with a finger, for example. The actuator 20 is typically adapted to provide a plurality of vibratory frequencies, wherein different frequencies are employed to communicate to the user changes to the operating condition of and receipt of an input to the control system 100, for example. It should be understood that additional components can be interposed between the haptic member 18 and the actuators 20 and the base 12 and the actuators 20. For example, an electrical conductive material and a dielectric material can be disposed between the haptic member 18 and the actuators 20 and the base 12 and the actuators 20 to facilitate the electrical communication between the haptic member 18 and the control system 100, and the actuators 20 and the control system 100.

A tuned mass damper 22 is coupled to the back surface 16 of the base 12. In the illustrated embodiment, a pair of tuned mass dampers 22 is shown. It should be understood that a single tuned mass damper 22 can be used and more than two tuned mass dampers 22 can be used. It should also be understood that the tuned mass damper can be coupled to the front surface 14 of the base, the haptic member 18, the actuator 20, and the support structure 50. Each tuned mass damper 22 dampens a peak amplitude of a vibration in a selected frequency domain. For example, the tuned mass damper 22 can dampen a single peak amplitude into two smaller peak amplitudes, wherein the two smaller peak amplitudes minimize a likelihood of causing undesired NVH characteristics in the support structure 50 and any other components attached thereto. It should be understood that the tuned mass damper 22 can be a linear tuned mass damper and a torsion tuned mass damper, wherein the tuned mass damper 22 includes a selected mass, a spring constant, and a damper to cooperate with the mass of the haptic interface assembly 10 and dissipate the energy input from the actuator 20 to the support structure 50.

In use, the user engages the haptic interface assembly 10. For example, the user can engage the haptic interface assembly 10 by touching the haptic member 18 with a finger to provide an input to the control system 100. Once the user engages the haptic interface assembly 10, the input is generated and transmitted to the control system 100. The control system 100 receives the input, analyzes the input, and generates an output to the actuator 20 effective to produce a known duty cycle therein. The known duty cycle from the actuator 20 produces a desired mechanical stimulation or vibration in the haptic interface assembly 10 having a known frequency domain and a peak amplitude. The vibration indicates to the user the operational status or condition of the associated system or device. The tuned mass damper 22 reduces the known peak amplitude of the vibration to minimize undesired NVH characteristics in the support structure 50 and other components attached thereto. For example, the tuned mass damper 22 can be designed to dampen a single peak amplitude into two smaller peak amplitudes. Different known duty cycles can be used to produce vibrations having different frequency domains and peak amplitudes to communicate to the user different operational statuses and conditions of the associated system or device. It should be understood that an individual tuned mass damper 22 can be provided for each duty cycle. Alternatively, it should be understood that an individual tuned mass damper 22 can be provided for selected duty cycles.

The tuned mass damper 22 has been found to be particularly useful as the total mass of the haptic interface assembly 10 increases. More energy is generally required to produce the desired haptic effect in the haptic interface assembly 10 as the total mass thereof increases. As the energy input is increased, the likelihood of producing undesired NVH characteristics in the support 50 and other components attached thereto also increases. The tuned mass damper 22 facilitates damping the vibrations in such haptic interfaces having greater total mass. Further, the use of the tuned mass damper 22 minimizes the need to add additional mass to the support 50 and other components attached thereto for the purpose of minimizing undesired NVH characteristics therein.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A haptic interface comprising:
a base having a front surface;
a haptic member disposed adjacent the front surface of the base to receive an input from a user, the haptic member in electrical communication with a control system, wherein the control system receives the input from the haptic member;
an actuator interposed between the base and the haptic member, the actuator in electrical communication with the control system, wherein the control system selectively provides an output to the actuator causing the actuator to produce a vibration of the haptic member, the vibration having a frequency domain and a peak amplitude;
a tuned mass damper coupled to the haptic interface, wherein the tuned mass damper minimizes the peak amplitude of the vibration.

2. The haptic interface according to claim 1, wherein the haptic member is a touch panel.

3. The haptic interface according to claim 1, wherein the haptic member is a touch screen.

4. The haptic interface according to claim 1, wherein the haptic member is a resistive sensing switch.

5. The haptic interface according to claim 1, wherein the haptic member is a capacitive sensing switch.

6. The haptic interface according to claim 1, wherein the input is effective to control an operation of the control system.

7. The haptic interface according to claim 1, further comprising a plurality of actuators interposed between the base and the haptic member.

8. The haptic interface according to claim 1, further comprising a plurality of tuned mass dampers coupled to the haptic interface, wherein the actuator can be activated to produce a plurality of vibrations having different frequency domains and peak amplitudes, each of the tuned mass dampers minimizing the peak amplitude of one of the vibrations.

9. The haptic interface according to claim 1, wherein the tuned mass damper is coupled to the base.

10. The haptic interface according to claim 1, wherein the haptic interface is coupled to a support structure, the tuned mass damper minimizing a transfer of the vibration from the haptic member to the support structure.

11. A haptic interface comprising:
a base having a front surface and a back surface;
a haptic member disposed adjacent the front surface of the base to receive an input from a user,
an actuator interposed between the base and the haptic member,
a control system in electrical communication with the haptic member and the actuator, wherein the control system receives the input from the haptic member effective to control an operation of the control system and selectively provides an output to the actuator to produce a vibration of the haptic member, the vibration having a frequency domain and a peak amplitude; and
a tuned mass damper coupled to the haptic interface, wherein the tuned mass damper minimizes the peak amplitude of the vibration.

12. The haptic interface according to claim 11, wherein the haptic member is a touch panel.

13. The haptic interface according to claim 11, wherein the haptic member is a touch screen.

14. The haptic interface according to claim 11, wherein the haptic member is one of a resistive sensing switch and a capacitive sensing switch.

15. The haptic interface according to claim 11, further comprising a plurality of actuators interposed between the base and the haptic member.

16. The haptic interface according to claim 11, further comprising a plurality of tuned mass dampers coupled to the haptic interface, wherein the actuators can be activated to produce a plurality of vibrations having different frequency domains and peak amplitudes, each of the tuned mass dampers minimizing the peak amplitude of one of the vibrations.

17. The haptic interface according to claim 11, wherein the tuned mass damper is coupled to the back surface of the base.

18. The haptic interface according to claim 11, wherein the haptic interface is coupled to a support structure, the tuned mass damper minimizing a transfer of the vibration from the haptic member to the support structure.

19. A method for dampening a vibration in a haptic interface, the method comprising the steps of:
providing a haptic interface comprising a base having a front surface; a haptic member disposed adjacent the front surface of the base to receive an input from a user, the haptic member in electrical communication with a control system, wherein the control system receives the input from the haptic member; an actuator interposed between the base and the haptic member, the actuator in electrical communication with the control system, wherein the control system selectively provides an output to the actuator causing the actuator to produce a vibration of the haptic member, the vibration having a frequency domain and a peak amplitude; and a tuned mass damper coupled to the haptic interface; and
mounting the haptic interface to a support structure, wherein the tuned mass damper minimizes the peak amplitude of the vibration to minimize a transfer of the vibration from the haptic member to the support structure.

20. The method according to claim 19, including the step of providing a plurality of tuned mass dampers coupled to the haptic interface, wherein the actuator can be activated to produce a plurality vibrations having different frequency domains and peak amplitudes, each of the tuned mass dampers minimizing the peak amplitude of one of the vibrations.
